(19) United States
(12) Patent Application Publication
(10) Pub. No.: US 2014/0020824 A1
(43) Pub. Date: Jan. 23, 2014

(54) Method of Annealing Liquid Crystal

(71) Applicant: FAR EASTERN NEW CENTURY CORPORATION, Taipei (TW)

(72) Inventors: Yu-June Wu, Zhongli City (TW); Da-Ren Chiou, Zhongli City (TW); Wei-Che Hung, Zhongli City (TW)

(73) Assignee: FAR EASTERN NEW CENTURY CORPORATION, Taipei (TW)

(21) Appl. No.: 13/727,062

(22) Filed: Dec. 26, 2012

(30) Foreign Application Priority Data
Jul. 20, 2012 (TW) 101126241

(51) Int. Cl. G02F 1/1333

(52) U.S. Cl. CPC G02F 1/1333
USPC 156/275.5

(57) ABSTRACT

A method for annealing liquid crystal is provided. First, a substrate having a liquid crystal layer thereon is provided, and a lens structure is disposed between the substrate and a contact surface of the liquid crystal layer. The liquid crystal layer fills and levels up the lens structure, and it has a thickness difference between the thickest portion and the thinnest portion in a range of 10 to 150 μm. An infrared light-absorbing layer having transmittance of infrared light in a range of 5 to 70% is covered on the liquid crystal layer. Infrared light is irradiated to the infrared light-absorbing layer to anneal the liquid crystal.

### RELATED APPLICATIONS

This application claims priority to Taiwan Application Serial Number 101126241, filed Jul. 20, 2012, which is herein incorporated by reference.

### BACKGROUND

1. Technical Field

The present disclosure relates to a method for annealing liquid crystal, and more particularly, to a method for rapidly annealing a liquid crystal layer having various thicknesses simultaneously.

2. Description of Related Art

Liquid crystal (LC) is a distinct phase of matter. With special physicochemical and optical properties, the liquid crystal has been widely applied to thin and light-weight display techniques since the last century.

A process of annealing is normally adopted to rearrange molecules of the liquid crystal. During the process of annealing the liquid crystal, an alignment film is used to control an arrangement direction of the liquid crystal molecules, such that the liquid crystal molecules can be rearranged along the predetermined arrangement direction of the alignment film.

Conventionally, the liquid crystal is annealed by a hot air heater to heat the liquid crystal molecules. However, using the hot air heater for annealing requires a long period of processing time. For example, Taiwan patent application (publication No. 201100489) disclosed that the time of annealing the liquid crystal was up to 1 hour. Further, if an infrared heater is used to replace the hot air heater to anneal the liquid crystal, the annealing time can be shorten but with the shortcoming of non-uniformly heating of the liquid crystal, which would be more worse when a layer of the liquid crystal having non-uniform thicknesses. Therefore, the industry desires to develop an effective method of shortening the time required for annealing the liquid crystal and without the side effects of the non-uniformly heating.

### SUMMARY

In order to solve the aforementioned problems in the related art, the present disclosure provides a method for uniformly heating liquid crystal and effectively shortening the time required for annealing the liquid crystal.

According to the present disclosure, a method for annealing the liquid crystal includes the steps below. First, a substrate having a liquid crystal layer thereon is provided. A lens structure is disposed between the substrate and a contact surface of the liquid crystal layer. The liquid crystal layer fills and levels up the lens structure, and the liquid crystal layer has a thickness difference ranging from 10 to 150 μm between the thickest portion and the thinnest portion. An infrared light-absorbing layer having a transmittance of infrared light in a range of 5 to 70% covers the liquid crystal layer. An infrared heater irradiates infrared light through the infrared light-absorbing layer to the substrate to heat it so as to anneal the liquid crystal and shorten the time of annealing the liquid crystal.

The method for annealing liquid crystal of the present disclosure can shorten the time required for annealing the liquid crystal and uniformly heat the liquid crystal layer simultaneously. When processing a liquid crystal layer having various thicknesses, the method for annealing the liquid crystal of the present disclosure shows superiority compared to the conventional art.

### BRIEF DESCRIPTION OF THE DRAWINGS

The disclosure may be more fully understood by reading the following detailed description of the embodiment, with reference made to the accompanying drawings as follows:

FIG. 1 is a schematic diagram of a method for annealing liquid crystal according to one embodiment of the present disclosure;

FIG. 2 is a cross-sectional view of a lens structure on a substrate according to another embodiment of the present disclosure;

FIG. 3 is a schematic diagram of a method for annealing liquid crystal to strengthen supporting property and structural strength of a substrate according to another embodiment of the present disclosure;

FIG. 4 is a schematic diagram of a method for annealing liquid crystal performed by a roll-to-roll process according to another embodiment of the present disclosure; and

FIG. 5 is a schematic diagram of a method for annealing liquid crystal, which adds an alignment layer, according to another embodiment of the present disclosure.

### DETAILED DESCRIPTION

The present disclosure is described by the following specific embodiments. Those with ordinary skill in the arts can readily understand the other advantages and functions of the present disclosure after reading the disclosure of this specification. The present disclosure can also be implemented with different embodiments. Various details described in this specification can be modified based on different viewpoints and applications without departing from the scope of the present disclosure.

As used herein, the singular forms “a,” “an” and “the” include plural referents unless the context clearly dictates otherwise. Therefore, reference to, for example, a data sequence includes aspects having two or more such sequences, unless the context clearly indicates otherwise.

Reference will now be made in detail to the embodiments of the present disclosure, examples of which are illustrated in the accompanying drawings. Wherever possible, the same reference numbers are used in the drawings and the description to refer to the same or like parts.

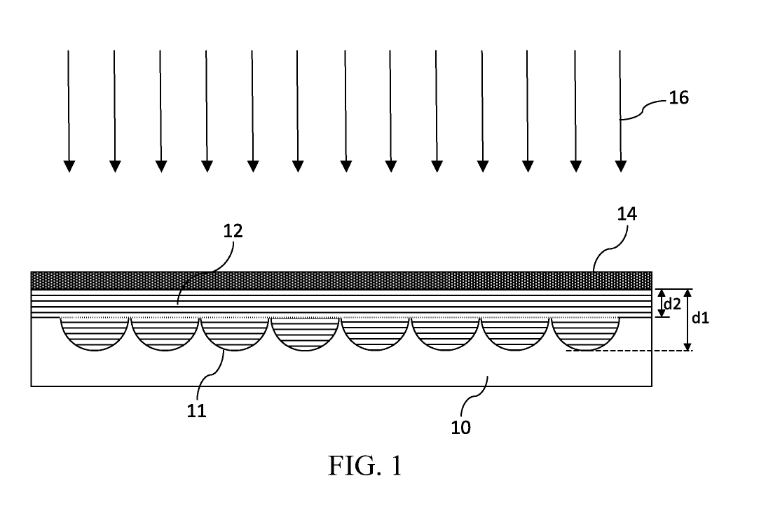

Please refer to FIG. 1, which is a schematic diagram of a method for annealing liquid crystal according to one embodiment of the present disclosure. First, a substrate 10 is provided, and at least one lens structure 11 is disposed on at least one side of the substrate 10. A liquid crystal layer 12 is coated on the side having the lens structure 11 of the substrate 10. The liquid crystal layer 12 fills and levels up the lens structure 11 on the substrate 10, and the opposite side which does not contacts to the substrate 10 is flat. Therefore, the liquid crystal layer 12 has various thicknesses. The thickest portion has a thickness d1, and the thinnest portion has a thickness d2. In the liquid crystal layer 12 with various thicknesses, a thickness difference Δd between the thickest portion and the thinnest portion is d1−d2. For considerations of optical applications, the thickness difference Δd is preferably in a range of 10 to 150 μm, better in a range of 20 to 130 μm, the best in a range of 35 to 120 μm.

Next, an infrared light-absorbing layer 14 covers the liquid crystal layer 12 to physically contact to the liquid crystal layer 12. The infrared light-absorbing layer 14 of the present disclosure is used to absorb and convert a portion of infrared light 16 into heat and let another portion of infrared light 16 pass through, which directly irradiates and heats up the liquid crystal layer 12. Therefore, during irradiation of the infrared light 16, the liquid crystal layer 12 is not only heated by the absorption of the infrared light 16 from the infrared light-absorbing layer 14 (i.e., conductive heat), but also heated by the direct irradiation of the infrared light 16 (i.e., radiation heat).

For considerations of applications of optical films, the aforementioned substrate 10 is preferably a transparent and flexible substrate, better made of an isotropic material (i.e., it does not have birefringence). The material of the substrate which can be applied of the present disclosure includes but not limited to acrylate resin, cellulose triacetate, epoxy resin, polysiloxane, polyimide, polyetherimide, perfluorocyclobutane, benzocyclobutene (BCB), polycarbonate, polymethyl methacrylate, polyurethane or poly (dimethyl siloxane), and better is acrylate resin and cellulose triacetate. The thickness of the substrate 10 of the present disclosure is not limited, and users can select a suitable thickness according to their demands.

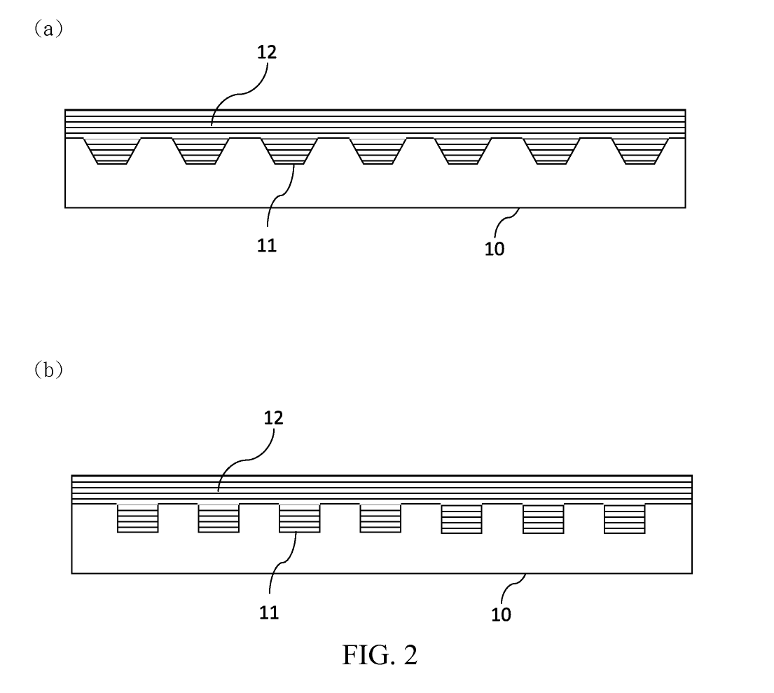

The shape of the lens structure 11 disposed on the substrate 10 of the present disclosure is not limited, and users can select a suitable shape according to their demands. FIG. 1 is exemplified as the lens structure 11 of the present disclosure, which the cross-section of the lens structure 11 may be semicircular, bowl-shaped or arc-shaped, and FIG. 2 is another example. The cross-section of the lens structure 11 can be a trapezoid shown in FIG. 2(a) or a square shown in FIG. 2(b). The aforementioned shapes can be individually presented or presented in a combination. When necessary, another lens structure can be disposed on the opposite side of the substrate, which can be projected outside or recessed inside. In this case, the shapes of the lens structures disposed on two opposite sides of the substrate 10 can be the same or different.

The thickness d2 of the thinnest portion of the liquid crystal layer 12 is not limited, and users can select a suitable thickness according to their demands. However, for considerations of applications of optical films, the thickness d2 of the thinnest portion of the liquid crystal layer 12 is preferably in a range of 1 to 10 μm, better in a range of 2 to 8 μm. Further, the liquid crystal which can be applied to the liquid crystal layer 12 of the present disclosure is not limited, and the conventional liquid crystals, which can be applied to optical films, can all be applied to the present disclosure. Specifically, the shape of the liquid crystal can be calamitic, discotic, smecdic or a combination thereof. More specifically, the aforementioned calamitic liquid crystal includes but not limited to nematic liquid crystal, cholesteric liquid crystal and smectic liquid crystal. The aforementioned discotic liquid crystal includes but not limited to columnar liquid crystal and nematic liquid crystal.

The method for forming the liquid crystal layer 12 is not limited, and includes but not limited to a spin coating method, a vacuum pressure method and a roll-to-roll lamination method.

In order to correspond to the substrate 10 and employ a roll-to-roll process, the infrared light-absorbing layer 14 is preferably flexible. The infrared light-absorbing layer 14 can be prepared by coating oil ink on a flexible transparent plastic substrate or mixing a pigment into a raw material of the flexible transparent plastic substrate and then extruding the flexible plastic substrate. The aforementioned oil ink or colorant refers to the material absorbing and converting infrared light to heat after irradiating infrared light. Further, in order to uniformly heat the liquid crystal layer 12, the infrared light-absorbing layer 14 preferably has transmittance of infrared light in a range of 5-70%, better in a range of 10 to 60%.

The coating thickness of the aforementioned oil ink on the plastic substrate is not limited, and users can understand the coating thickness of the oil ink can be adjusted according to the selected type of the oil ink so as to correspond to the transmittance of infrared light through the description of the present disclosure. Specifically, the coating thickness of the oil ink is preferably in a range of 0.1 to 2.0 μm, better in a range of 0.2 to 1.8 μm. The oil ink which can be applied to the present disclosure includes a two-liquid reaction type oil ink, a heat curable oil ink and an UV-curable ink, but not limited thereto. The two-liquid reaction type oil ink refers to a main agent and a curing agent, which are respectively prepared, and those agents are mixed during a printing process. The main agent is mostly composed of epoxy resin and urethane, and performs polycondensation reaction and thereby cured after adding the curing agent (e.g., amines). The aforementioned heat curable oil ink refers to a premixture composed of a resin and a curing agent, and those agents perform a reaction and thereby cured by heating after printing to form an oil ink film. The commonly used resin is a single-liquid epoxy resin. The aforementioned UV-curable ink refers to a resin without any solvent, and it does not evaporate solvent during printing and performs polymerization during irradiating UV to form an oil ink film.

The pigment which can be applied to the present disclosure is not limited, and the conventional pigments which can be mixed in a raw material of a flexible transparent plastic substrate can all be applied to the present disclosure. The specific examples of the pigment includes but not limited to natural inorganic pigments, artificial inorganic pigments and natural organic pigments, such as plant organic pigments or insect organic pigments.

The infrared light 16 of the present disclosure refers to the infrared light that any skilled in the art understands; more specifically, it refers to the light in a wavelength range of 750 to 1500 nm.

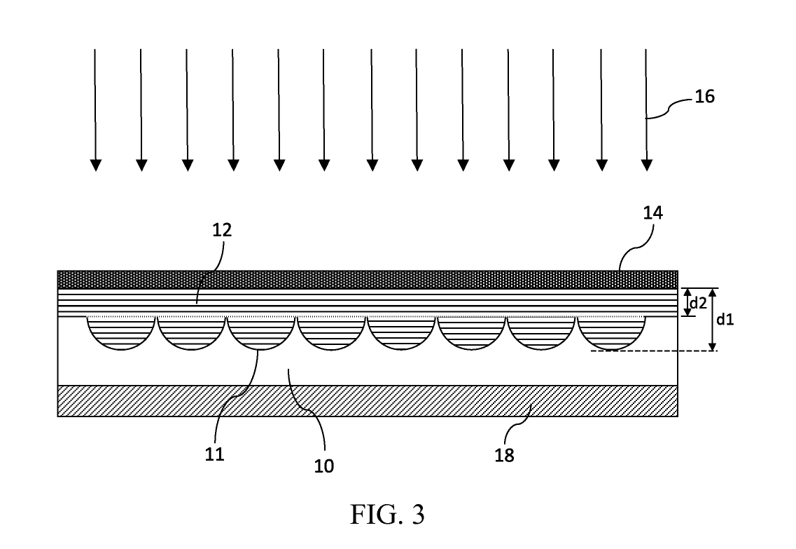

Please refer to FIG. 3, in order to strengthen the supporting property and the structural strength of the substrate 10, a supporting substrate 18 is disposed on another side of the substrate opposite to the side having the lens structure 11. The material of the supporting substrate 18 which can be applied to the present disclosure is not limited, and users can select a suitable material according to their demands. Specifically, the supporting substrate 18 is preferably flexible, which includes but not limited to polyethylene terephthalate, cellulose triacetate and polycarbonate.

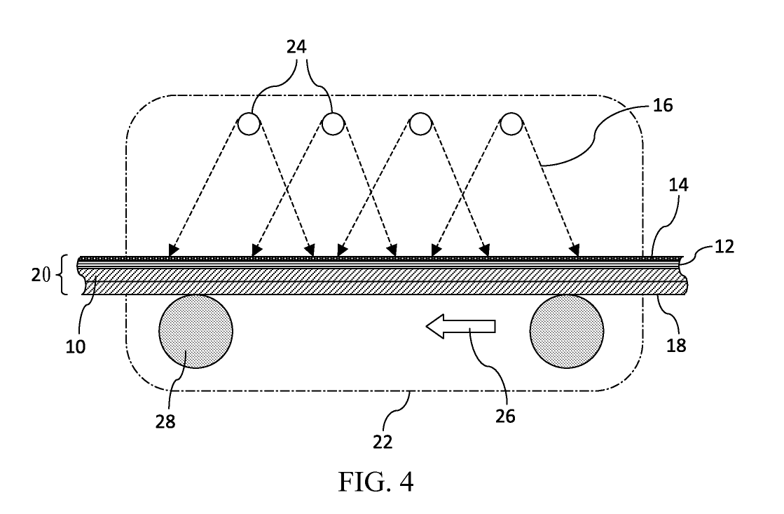

Please refer to FIG. 4, which is a schematic diagram of a method for annealing the liquid crystal by a roll-to-roll process. The stacked laminate 20 composed of the supporting substrate 18, the substrate 10, the liquid crystal layer 12 and the infrared light-absorbing layer 14 passes the roller 28 and is fed to the infrared heater 22 in a traveling direction during annealing the liquid crystal. With the infrared lamp 24 installed in the infrared heater 22, the liquid crystal layer 12 is heated by the infrared light-absorbing layer 14 by way of the irradiation of the infrared light 16 from to the laminate 20, and thereby to anneal the liquid crystal. After annealing the liquid crystal layer 12, the infrared light-absorbing layer 14 is peeled from the laminate 20.

In the method for annealing the liquid crystal of the present disclosure, users can adjust the heating temperature of the infrared heater 22 according to the selected type of the liquid crystal. Specifically, the heating temperature is preferably in a range of 70 to 100° C., better in a range of 75 to 90° C. The total heating time of the laminate 20 through the infrared heater 22 is not limited, and users can adjust in accordance with the heating temperature, the thickness of the liquid crystal layer and the thickness difference, and the transmittance of infrared light of the infrared light-absorbing layer. But overall, the heating time of annealing the liquid crystal of the present disclosure can be shortened to less than 20 minutes, and it has significant superiority compared to prior art which using hot air to heat requires 1 hour or more.

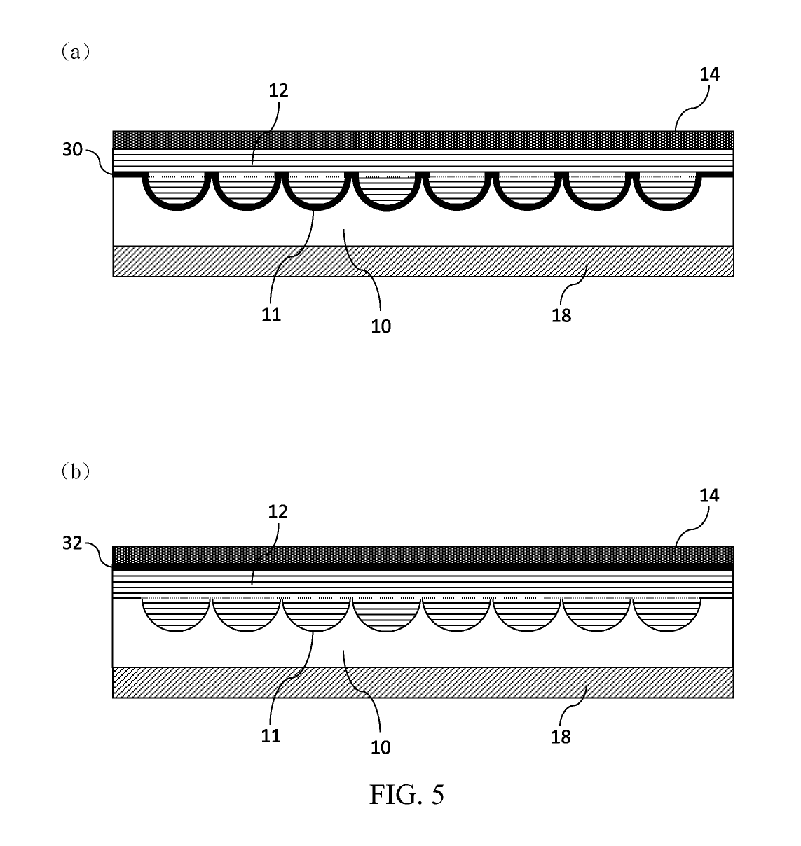

Before aligning the liquid crystal layer 12, liquid crystal molecules usually arrange in non-uniform directions, and the situation is not conductive to applications of the field of optical films. In order to align the liquid crystal molecules of the liquid crystal layer 12 in a predetermined direction, an alignment layer 30 can be disposed on the lens structure 11 of the substrate 10, as shown in FIG. 5(a). Please refer to FIG. 5(b), an alignment layer 32 also can be disposed on a side of the infrared light-absorbing layer 14. When the thickest portion of the liquid crystal layer 12 is thicker, two alignment layers can respectively be disposed on the aforementioned two positions to exhibit a better alignment effect of the liquid crystal molecules.

Users can select a suitable method for forming the alignment layer and the materials of the alignment layer according to their needs, but not limited thereto. The method for forming the alignment layer includes rubbing alignment, photo-alignment, ion beam alignment and plasma beam alignment, but not limited thereto.

### Example 1

### Preparation of Laminate of Liquid Crystal Layer Having Various Thicknesses

A polyethylene terephthalate substrate having a thickness of 100 μm and a size of 10 cm×10 cm (PET 4100, purchased from Toyobo Co, Ltd., Japan) is prepared, and an acrylic resin layer is coated thereon. An engraving copper wheel is used to imprint the acrylic resin layer to form lens structures (bowl structures are recessed inside the surface of the acrylic resin layer, and each of the bowl structures has a width of 250 μm and a depth of 40 μm).

A light alignment layer (ROP103, purchased from Rolic) having a thickness of 100 μm is spin-coated on the side having the lens structure of the substrate. Next, a light alignment apparatus (PUV DEEP, purchased from USHIO) is used to align the alignment layer in a predetermined direction (an angle of 45° to the traveling direction of the light alignment layer). Finally, liquid crystal (UV curable liquid crystal, LC242, purchased from BASF, Germany, in which a photo initiator (TPO, purchased from BASF, Germany) is mixed therein, and the adding amount thereof is 1 wt % based on the total weight) is coated on the light alignment layer to fully fill the lens structure and to form a flat opposite surface of the liquid crystal layer. Therefore, a liquid crystal layer having various thicknesses is prepared. The thickness of the thinnest portion of the liquid crystal layer is 1 μm, and that of the thickest portion is 41 μm. The thickness difference is 40 μm.

### Preparation of Infrared Absorbing Layer

A polyethylene terephthalate substrate having a thickness of 100 μm (PET 4100, purchased from Toyobo Co, Ltd., Japan) is prepared, and a heat curable black oil ink layer (solid content 35%, and the main component is carbon black, A92, purchased from Taipolo Technology Co. Ltd., R.O.C) is uniformly coated on one side of the substrate by a R.D.S. Webster No. 8 bar. After uniformly coating, the solvent of the oil ink is removed (heated by a hot plate, 70° C. for 1 minute) to form an oil ink layer having a thickness of 0.3 μm. The transmittance of infrared light in a wavelength range of 750 to 1500 nm of the whole infrared absorbing layer is 57.4% measured by a spectrometer (U4100, purchased from Hitachi Co. Ltd., Japan).

The infrared absorbing layer is adhered on the aforementioned laminate to let the side free of the oil ink layer contact to the liquid crystal layer, and then fed to a roll-to-roll infrared heater (self-assembly, infrared lamp can irradiate infrared light in a wavelength range of 750 to 1500 nm, 110V/300 W). The heating temperature is set at 80° C., and the running speed is 0.2 m/min. The total heating time is 5 minutes. Finally, after heating, it is stood to cool to ambient temperature in an environment having ambient temperature to thereby complete the process of annealing the liquid crystal.

After annealing the liquid crystal layer, the alignment situation of the liquid crystal is detected by a polarizing microscope (XP201, purchased from Kingyoup Enterprise Co., Ltd.). The obtained results are represented in the manner hereinafter and summarized in Table 1:
(1) good liquid crystal alignment is represented by “o”, which there is no liquid crystal alignment abnormal region in the area corresponding to the lens structure of the liquid crystal layer;
(2) acceptable liquid crystal alignment is represented by “Δ”, which there is/are 1 to 3 liquid crystal alignment abnormal region(s) in the area corresponding to the lens structure of the liquid crystal layer; and
(3) poor liquid crystal alignment is represented by “x”, which there are more than 3 liquid crystal alignment abnormal regions in the area corresponding to the lens structure of the liquid crystal layer.

In the test results, “o” or “Δ” indicates that the quality is in an acceptable range, and “o” indicates that the quality is the best.

Deformation of the whole surface may occur because the materials are non-uniformly heated with various heating rates, since the composite layers fed to the infrared heater are composed of various materials and those materials respectively have different thermal expansion coefficients. The deformation would cause abnormal alignment during aligning the liquid crystal. Also, disclination lines may be produced during abnormal alignment of the liquid crystal; that is, the liquid crystal molecules are arranged in irregular directions in the peripheral area of the disclination lines. Hence, light leakage may occur when light passes through the area, and thus impacts on the image display quality of a liquid crystal display device.

### Example 2

The preparations of the testing materials and the related experimental operations are the same as those of Example 1, but the coating thickness of the oil ink is changed to 0.9 μm. The transmittance of infrared light in a wavelength range of 750 to 1500 nm of the whole infrared absorbing layer is 20.3% measured by the spectrometer, and the obtained result is listed in Table 1.

### Example 3

The preparations of the testing materials and the related experimental operations are the same as those of Example 1, but the coating thickness of the oil ink is changed to 1.6 μm. The transmittance of infrared light in a wavelength range of 750 to 1500 nm of the whole infrared absorbing layer is 10.6% measured by the spectrometer, and the obtained result is listed in Table 1.

### Example 4

The preparations of the testing materials and the related experimental operations are the same as those of Example 1, but the coating thickness of the oil ink is changed to 2.3 μm. The transmittance of infrared light in a wavelength range of 750 to 1500 nm of the whole infrared absorbing layer is 0.4% measured by the spectrometer, and the obtained result is listed in Table 1.

### Comparative Example 1

The preparations of the testing materials and the related experimental operations are the same as those of Example 1, but there is no oil ink layer formed on the polyethylene terephthalate substrate (the thickness of the oil ink layer is 0 μm). The transmittance of infrared light in a wavelength range of 750 to 1500 nm of the whole infrared absorbing layer is 89% measured by the spectrometer, and the obtained result is listed in Table 1.

TABLE 1

| | Thickness | Transmittance of | Liquid crystal |
|---|---|---|---|
| | of oil ink | infrared light | alignment |
| | (μm) | (%) | situation |
| Example 1 | 0.3 | 57.4 | ∘ |
| Example 2 | 0.9 | 20.3 | Δ |
| Example 3 | 1.6 | 10.6 | Δ |
| Example 4 | 2.3 | 0.4 | x |
| Comparative Example 1 | 0 | 89 | x |

### Example 5

The preparations of the testing materials and the related experimental operations are the same as those of Example 1, but the heating time is changed to 10 minutes. The obtained result is listed in Table 2.

### Example 6

The preparations of the testing materials and the related experimental operations are the same as those of Example 2, but the heating time is changed to 10 minutes. The obtained result is listed in Table 2.

### Example 7

The preparations of the testing materials and the related experimental operations are the same as those of Example 3, but the heating time is changed to 10 minutes. The obtained result is listed in Table 2.

### Example 8

The preparations of the testing materials and the related experimental operations are the same as those of Example 4, but the heating time is changed to 10 minutes. The obtained result is listed in Table 2.

### Comparative Example 2

The preparations of the testing materials and the related experimental operations are the same as those of Comparative Example 1, but the heating time is changed to 10 minutes. The obtained result is listed in Table 2.

TABLE 2

| | Thickness | Transmittance of | Liquid crystal |
|---|---|---|---|
| | of oil ink | infrared light | alignment |
| | (μm) | (%) | situation |
| Example 5 | 0.3 | 57.4 | ∘ |
| Example 6 | 0.9 | 20.3 | ∘ |
| Example 7 | 1.6 | 10.6 | Δ |
| Example 8 | 2.3 | 0.4 | x |
| Comparative Example 2 | 0 | 89 | x |

### Example 9

The preparations of the testing materials and the related experimental operations are the same as those of Example 1, but the heating time is changed to 15 minutes. The obtained result is listed in Table 3.

### Example 10

The preparations of the testing materials and the related experimental operations are the same as those of Example 2, but the heating time is changed to 15 minutes. The obtained result is listed in Table 3.

### Example 11

The preparations of the testing materials and the related experimental operations are the same as those of Example 3, but the heating time is changed to 15 minutes. The obtained result is listed in Table 3.

### Example 12

The preparations of the testing materials and the related experimental operations are the same as those of Example 4, but the heating time is changed to 15 minutes. The obtained result is listed in Table 3.

### Comparative Example 3

The preparations of the testing materials and the related experimental operations are the same as those of Comparative Example 1, but the heating time is changed to 15 minutes. The obtained result is listed in Table 3.

TABLE 3

| | Thickness | Transmittance of | Liquid crystal |
|---|---|---|---|
| | of oil ink | infrared light | alignment |
| | (μm) | (%) | situation |
| Example 9 | 0.3 | 57.4 | x |
| Example 10 | 0.9 | 20.3 | ∘ |
| Example 11 | 1.6 | 10.6 | ∘ |
| Example 12 | 2.3 | 0.4 | x |
| Comparative Example 3 | 0 | 89 | x |

### Example 13

The preparations of the testing materials and the related experimental operations are the same as those of Example 1, but the thickness difference is changed to 85 μm. The obtained result is listed in Table 4.

### Example 14

The preparations of the testing materials and the related experimental operations are the same as those of Example 2, but the thickness difference is changed to 85 μm. The obtained result is listed in Table 4.

### Example 15

The preparations of the testing materials and the related experimental operations are the same as those of Example 3, but the thickness difference is changed to 85 μm. The obtained result is listed in Table 4.

### Example 16

The preparations of the testing materials and the related experimental operations are the same as those of Example 4, but the thickness difference is changed to 85 μm. The obtained result is listed in Table 4.

### Comparative Example 4

The preparations of the testing materials and the related experimental operations are the same as those of Comparative Example 1, but the thickness difference is changed to 85 μm. The obtained result is listed in Table 4.

TABLE 4

| | Thickness | Transmittance of | Liquid crystal |
|---|---|---|---|
| | of oil ink | infrared light | alignment |
| | (μm) | (%) | situation |
| Example 13 | 0.3 | 57.4 | ∘ |
| Example 14 | 0.9 | 20.3 | Δ |
| Example 15 | 1.6 | 10.6 | x |
| Example 16 | 2.3 | 0.4 | x |
| Comparative Example 4 | 0 | 89 | x |

### Example 17

The preparations of the testing materials and the related experimental operations are the same as those of Example 13, but the heating time is changed to 10 minutes. The obtained result is listed in Table 5.

### Example 18

The preparations of the testing materials and the related experimental operations are the same as those of Example 14, but the heating time is changed to 10 minutes. The obtained result is listed in Table 5.

### Example 19

The preparations of the testing materials and the related experimental operations are the same as those of Example 15, but the heating time is changed to 10 minutes. The obtained result is listed in Table 5.

### Example 20

The preparations of the testing materials and the related experimental operations are the same as those of Example 16, but the heating time is changed to 10 minutes. The obtained result is listed in Table 5.

### Comparative Example 5

The preparations of the testing materials and the related experimental operations are the same as those of Comparative Example 4, but the heating time is changed to 10 minutes. The obtained result is listed in Table 5.

TABLE 5

| | Thickness | Transmittance of | Liquid crystal |
|---|---|---|---|
| | of oil ink | infrared light | alignment |
| | (μm) | (%) | situation |
| Example 17 | 0.3 | 57.4 | ∘ |
| Example 18 | 0.9 | 20.3 | ∘ |
| Example 19 | 1.6 | 10.6 | Δ |
| Example 20 | 2.3 | 0.4 | x |
| Comparative Example 5 | 0 | 89 | x |

### Example 21

The preparations of the testing materials and the related experimental operations are the same as those of Example 13, but the heating time is changed to 15 minutes. The obtained result is listed in Table 6.

### Example 22

The preparations of the testing materials and the related experimental operations are the same as those of Example 14, but the heating time is changed to 15 minutes. The obtained result is listed in Table 6.

### Example 23

The preparations of the testing materials and the related experimental operations are the same as those of Example 15, but the heating time is changed to 15 minutes. The obtained result is listed in Table 6.

### Example 24

The preparations of the testing materials and the related experimental operations are the same as those of Example 16, but the heating time is changed to 15 minutes. The obtained result is listed in Table 6.

### Comparative Example 6

The preparations of the testing materials and the related experimental operations are the same as those of Comparative Example 4, but the heating time is changed to 15 minutes. The obtained result is listed in Table 6.

TABLE 6

| | Thickness | Transmittance of | Liquid crystal |
|---|---|---|---|
| | of oil ink | infrared light | alignment |
| | (μm) | (%) | situation |
| Example 21 | 0.3 | 57.4 | x |
| Example 22 | 0.9 | 20.3 | ∘ |
| Example 23 | 1.6 | 10.6 | ∘ |
| Example 24 | 2.3 | 0.4 | x |
| Comparative Example 6 | 0 | 89 | x |

### Example 25

The preparations of the testing materials and the related experimental operations are the same as those of Example 1, but the thickness difference is changed to 113 μm. The obtained result is listed in Table 7.

### Example 26

The preparations of the testing materials and the related experimental operations are the same as those of Example 2, but the thickness difference is changed to 113 μm. The obtained result is listed in Table 7.

### Example 27

The preparations of the testing materials and the related experimental operations are the same as those of Example 3, but the thickness difference is changed to 113 μm. The obtained result is listed in Table 7.

### Example 28

The preparations of the testing materials and the related experimental operations are the same as those of Example 4, but the thickness difference is changed to 113 μm. The obtained result is listed in Table 7.

### Comparative Example 7

The preparations of the testing materials and the related experimental operations are the same as those of Comparative Example 1, but the thickness difference is changed to 113 μm. The obtained result is listed in Table 7.

TABLE 7

| | Thickness | Transmittance of | Liquid crystal |
|---|---|---|---|
| | of oil ink | infrared light | alignment |
| | (μm) | (%) | situation |
| Example 25 | 0.3 | 57.4 | x |
| Example 26 | 0.9 | 20.3 | x |
| Example 27 | 1.6 | 10.6 | x |
| Example 28 | 2.3 | 0.4 | x |
| Comparative Example 7 | 0 | 89 | x |

### Example 29

The preparations of the testing materials and the related experimental operations are the same as those of Example 25, but the heating time is changed to 10 minutes. The obtained result is listed in Table 8.

### Example 30

The preparations of the testing materials and the related experimental operations are the same as those of Example 26, but the heating time is changed to 10 minutes. The obtained result is listed in Table 8.

### Example 31

The preparations of the testing materials and the related experimental operations are the same as those of Example 27, but the heating time is changed to 10 minutes. The obtained result is listed in Table 8.

### Example 32

The preparations of the testing materials and the related experimental operations are the same as those of Example 28, but the heating time is changed to 10 minutes. The obtained result is listed in Table 8.

### Comparative Example 8

The preparations of the testing materials and the related experimental operations are the same as those of Comparative Example 7, but the heating time is changed to 10 minutes. The obtained result is listed in Table 8.

TABLE 8

| | Thickness | Transmittance of | Liquid crystal |
|---|---|---|---|
| | of oil ink | infrared light | alignment |
| | (μm) | (%) | situation |
| Example 29 | 0.3 | 57.4 | ∘ |
| Example 30 | 0.9 | 20.3 | Δ |
| Example 31 | 1.6 | 10.6 | x |
| Example 32 | 2.3 | 0.4 | x |
| Comparative Example 8 | ∘ | 89 | x |

### Example 33

The preparations of the testing materials and the related experimental operations are the same as those of Example 25, but the heating time is changed to 15 minutes. The obtained result is listed in Table 9.

### Example 34

The preparations of the testing materials and the related experimental operations are the same as those of Example 26, but the heating time is changed to 15 minutes. The obtained result is listed in Table 9.

### Example 35

The preparations of the testing materials and the related experimental operations are the same as those of Example 27, but the heating time is changed to 15 minutes. The obtained result is listed in Table 9.

### Example 36

The preparations of the testing materials and the related experimental operations are the same as those of Example 28, but the heating time is changed to 15 minutes. The obtained result is listed in Table 9.

### Comparative Example 9

The preparations of the testing materials and the related experimental operations are the same as those of Comparative Example 7, but the heating time is changed to 15 minutes. The obtained result is listed in Table 9.

TABLE 9

| | Thickness | Transmittance of | Liquid crystal |
|---|---|---|---|
| | of oil ink | infrared light | alignment |
| | (μm) | (%) | situation |
| Example 33 | 0.3 | 57.4 | ∘ |
| Example 34 | 0.9 | 20.3 | ∘ |
| Example 35 | 1.6 | 10.6 | Δ |
| Example 36 | 2.3 | 0.4 | x |
| Comparative Example 9 | 0 | 89 | x |

### Comparative Example 10

The preparations of the testing materials and the related experimental operations are the same as those of Comparative Example 1, but a hot air oven is utilized to heat, and the heating time and the thickness difference of the liquid crystal layer are changed. The obtained results are listed in Table 10.

TABLE 10

| Heating time | Thickness difference | Liquid crystal alignment |
|---|---|---|
| (min) | (μm) | situation |
| 5 | 40 | x |
| 30 | 40 | Δ |
| 30 | 85 | x |
| 60 | 40 | ∘ |
| 60 | 85 | Δ |
| 60 | 113 | x |

The results indicates that the method for annealing the liquid crystal of the present disclosure can shorten the heating time compared to a hot-air method; further, the liquid crystal layer is uniformly heated compared to a heating method by using only an infrared heater (i.e., there is no infrared absorbing layer of the present disclosure covering the liquid crystal layer). Directly heating the liquid crystal by using the infrared heater is fast, but deformation of the liquid crystal layer occurs due to non-uniform heating. Although the method of the present disclosure requires more heating time (but still less than the heating time of the hot-air method) than the heating method using the infrared heater, the liquid crystal layer is uniformly heated to effectively and rapidly anneal the liquid crystal.

Although the present disclosure has been described in considerable detail with reference to certain embodiments thereof, other embodiments are possible. Therefore, the spirit and scope of the appended claims should not be limited to the description of the embodiments contained herein.

It will be apparent to those ordinarily skilled in the art that various modifications and variations may be made to the structure of the present disclosure without departing from the scope or spirit of the disclosure. In view of the foregoing, it is intended that the present disclosure cover modifications and variations thereof provided they fall within the scope of the following claims.

What is claimed is:

1. A method for annealing liquid crystal, comprising the steps of:
providing a substrate having a liquid crystal layer thereon, a lens structure disposed between the substrate and a contact surface of the liquid crystal layer, wherein the liquid crystal layer fills and levels up the lens structure, and the liquid crystal layer has a thickness difference ranging from 10 to 150 μm between the thickest portion and the thinnest portion;
covering an infrared light-absorbing layer on the liquid crystal layer; and
irradiating infrared light to the infrared light-absorbing layer,
wherein the infrared light-absorbing layer has a transmittance of infrared light in a range of 5 to 70%.

2. The method of claim 1, wherein the infrared light-absorbing layer is a flexible substrate having an oil ink thereon, wherein the oil ink absorbs and converts the infrared light into heat.

3. The method of claim 2, wherein the oil ink has a thickness in a range of 0.1 to 2.0 μm.

4. The method of claim 2, wherein the oil ink has a thickness in a range of 0.2 to 1.8 μm.

5. The method of claim 2, wherein the oil ink is a two-liquid reaction type oil ink, a heat curable ink or an ultraviolet (UV) curable ink.

6. The method of claim 2, wherein the flexible substrate is made of polyethylene terephthalate, cellulose triacetate or polycarbonate.

7. The method of claim 1, wherein the infrared light-absorbing layer is a flexible substrate having a pigment, which the pigment absorbs and converts the infrared light into heat.

8. The method of claim 1, wherein the thickness difference of the liquid crystal layer between the thickest portion and the thinnest portion is in a range of 20 to 130 μm.

9. The method of claim 1, wherein the thickness difference of the liquid crystal layer between the thickest portion and the thinnest portion is in a range of 35 to 120 μm.

10. The method of claim 1, wherein the infrared light-absorbing layer has a transmittance of infrared light in a range of 10 to 60%.

11. The method of claim 1, wherein the step of irradiating the infrared light is performing by an infrared heater.

12. The method of claim 11, wherein the infrared heater has a heating temperature in a range of 70 to 100° C.

13. The method of claim 11, wherein the infrared heater has a heating time not more than 20 minutes.

14. The method of claim 1, wherein the lens structure has a cross-section in a form of a square, a trapezoid, a camber, a semi-circle, a bowl or a combination thereof.

15. The method of claim 1, wherein the substrate is made of acrylic resin or cellulose triacetate.

16. The method of claim 1, further the step of adhering a supporting substrate beneath the substrate.

17. The method of claim 1, wherein the flexible substrate is made of polyethylene terephthalate, cellulose triacetate or polycarbonate.

18. The method of claim 1, further comprising the step of disposing an alignment layer between the substrate and the liquid crystal layer.

19. The method of claim 1, further comprising the step of deposing an alignment layer between the infrared light-absorbing layer and the contact surface of the liquid crystal layer.
